(19) United States
(12) Patent Application Publication
(10) Pub. No.: US 2017/0046684 A1
(43) Pub. Date: Feb. 16, 2017

(54) USING A CLIENT TERMINAL WIRELESS PERSONAL AREA NETWORK (WPAN) TRANSCEIVER FOR SECURE ELEMENT COMMUNICATION

(71) Applicant: Wise-Sec Ltd., Yokneam (IL)

(72) Inventor: Vadim MAOR, Kiryat-Tivon (IL)

(21) Appl. No.: 15/304,526

(22) PCT Filed: Apr. 15, 2015
(86) PCT No.: PCT/IL2015/050406

§ 371 Date: Oct. 16, 2016

Related U.S. Application Data
(60) Provisional application No. 61/980,616, filed on Apr. 17, 2014.

(51) Int. Cl. G06Q 20/34; H04W 12/06; H04W 4/00; H04L 29/06; G06Q 20/32

(52) U.S. Cl. CPC G06Q 20/341; H04L 63/0428; H04L 63/0853; G06Q 20/325; H04W 4/008; H04W 12/06; H04L 2209/56; H04L 2209/80; G06Q 2220/00

(57) ABSTRACT

An electronic card connectable to a client terminal via a secure element (SE) reader slot. The electronic card comprises a housing sized to be inserted into an SE reader slot of a client terminal that has an SE slot width and an SE slot length and a WPAN transceiver, a secure memory which stores security data, a WPAN card unit electronically wired to a WPAN antenna used to receive wirelessly authentication data, the WPAN antenna having WPAN antenna width and WPAN antenna length which are respectively smaller than the SE slot width and the SE slot length, and an execution environment having at least one processor which encrypts the authentication data using the security data in a data command and instructs the transmission of the data command by the WPAN electronic card unit to the WPAN transceiver for further transmission of the data command by the WPAN transceiver.

### BACKGROUND

The present invention, in some embodiments thereof, relates to data transfer protocols and methods and, more specifically, but not exclusively, to data transfer protocols and methods which are implemented using an SE electronic card.

A near field communication (NFC) technology is a standards-based wireless communication technology that allows data to be exchanged between devices that are a few centimeters apart. NFC operates at 13.56 MHz and transfers data at up to 424 Kbits/second.

An NFC-enabled device is provisioned with a payment application and payment account information (i.e. credit card or debit card) issued by the consumer's financial institution. The application and payment account information are encrypted and stored in a secure area in the device. The device uses NFC technology to communicate with the merchant's contactless payment-capable POS system, similar to other contactless payment cards and devices.

NFC mobile contactless payments can be made at both attended POS locations (such as stores) and unattended locations (such as vending machines) that use the existing merchant payments infrastructure. To pay, the consumer simply brings the device to within a few inches of a contactless payment-capable POS system and the transaction occurs. The process is the same as that used by the contactless credit and debit cards currently being deployed globally.

Usually, NFC-enabled credit and debit payment applications are secured by storing personal information, including financial information such as an account number and expiration date, in a secured area in the NFC device, commonly referred to as a secure element.

The secure element is usually a dynamic environment that includes a secure memory and an execution environment. In the dynamic environment application code and application data are securely stored and administered and in which secure execution of applications occurs. The secure element usually resides in a highly secure crypto chip, such as a smart card chip. The secure element provides delimited memory for each application and other functions that can encrypt, decrypt, and sign the data packet. The secure element may be implemented by a separate secure smart card chip, a Subscriber Identification Module (SIM)/Union for International Cancer Control (UICC), or in a secure digital (SD) card and/or any dynamic environment that is set to be inserted in the device, for example a mobile phone, a wearable device, or a tablet.

In use, data such as the personal information from the secured element, for example the SIM/UICC card is transferred to a reader which is external to the device by an NFC channel formed by an NFC module of the device. The data is transferred directly from the secure element to the NFC radio without passing the application layer.

### SUMMARY

According to an aspect of some embodiments of the present invention there is provided an electronic card connectable to a client terminal via a secure element (SE) reader slot, the electronic card comprises a housing sized to be inserted into an SE reader slot of a client terminal that has an SE slot width and an SE slot length and a wireless personal area network (WPAN) transceiver, a secure memory which stores security data, a WPAN card unit electronically wired to a WPAN antenna that is used to receive wirelessly authentication data, the WPAN antenna having WPAN antenna width and WPAN antenna length which are respectively smaller than the SE slot width and the SE slot length, and an execution environment having at least one processor which encrypts the authentication data using the security data in a data command and instructs the transmission of the data command by the WPAN electronic card unit to the WPAN transceiver for further transmission of the data command by the WPAN transceiver. The housing contains the secure memory, and the WPAN card unit.

Optionally, the WPAN card unit and the WPAN transceiver are Bluetooth transceiver modules.

Optionally, the electronic card comprises a card interface having at least one power supply pin set to be connected to at least one source terminal in the SE reader slot; wherein the housing contains the card interface; wherein the WPAN card unit set to be powered via the at least one power supply pin.

More optionally, the electronic card comprises a Subscriber Identification Module (SIM) circuit set to be powered via the at least one power supply pin and to communicate with a client terminal execution environment of the client terminal for establishing a cellular connection.

Optionally, the SE slot width and the SE slot length and are respectively about 15 mm and about 25 mm or about 15 mm and about 12 mm.

Optionally, the client terminal is a cellular device.

Optionally, the execution environment instructs the transmission of the data command by the WPAN electronic card unit to the WPAN transceiver via a mobile application processor.

More optionally, the authentication data is received from the mobile application processor.

Optionally, the WPAN electronic card unit directly and wirelessly sends the data command to the WPAN transceiver via a wireless connection.

According to an aspect of some embodiments of the present invention there is provided a method for using a wireless personal area network (WPAN) transceiver of a client terminal for secure element (SE) communication. The method comprises providing an SE electronic card sized to be inserted into an SE reader slot of a client terminal having a wireless personal area network (WPAN) transceiver, where the SE reader slot having an SE slot width and an SE slot length and the SE electronic card includes, an execution environment having at least one processor, a secure memory which stores security data and a WPAN antenna having WPAN antenna width and WPAN antenna length which are respectively smaller than the SE slot width and the SE slot length, wirelessly receiving authentication data card at the SE electronic and using the WPAN antenna, locally generating at the execution environment a data command encrypting the authentication data using the security data, and transmitting the data command, using the WPAN antenna, to the WPAN transceiver for further transmission of the data command by the WPAN transceiver.

Optionally, the data command is sent to confirm a payment using the client terminal.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are sequence diagrams of processes wherein an SE electric card is used for generating a data command transmitted to a WPAN transceiver of a client terminal for further transmission to a reader of an external device, according to some embodiments of the present invention; and

FIGS. 2A and 2B are schematic illustrations of SE electronic cards 300 connectable to a client terminal, an SE reader 302 that wirelessly communicate with the SE electronic cards via a WPAN transceiver of a client terminal and a backend, such as a point of sale, according to some embodiments of the present invention.

### DETAILED DESCRIPTION

The present invention, in some embodiments thereof, relates to data transfer protocols and methods and, more specifically, but not exclusively, to data transfer protocols and methods which are implemented using an SE electronic card.

According to some embodiments of the present invention, there are provided methods and systems of using a client terminal wireless personal area network (WPAN) transceiver of a client terminal for repeating, for example amplifying data commend, a message, encrypted by a SE embedded in an electronic card that inserted into a socket of the client terminal, such as a SIM card reader slot.

The methods and systems allow using client terminals which do not have NFC modules or NFC module APIs which allow some applications to use NFC modules to perform a secured transaction using data stored in the memory of an SE circuit that is installed in an electronic card in the socket of the client terminal.

The repeating, for example for amplification, of the encrypted data from the SE circuit that is installed in an electronic card allows avoiding using an antenna that exceeds the size of the socket of the client terminal. In such a manner, a standard SIM card sized electronic card, optionally embedded with a SIM circuit and an SE circuit as described below, may be used for performing data transaction, such as payments.

The electronic card has a WPAN card unit that is connected to WPAN antenna which does not exceed the size of the electronic card itself. In such a manner, the electronic card fits as a whole in a standard card slot of the client terminal.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

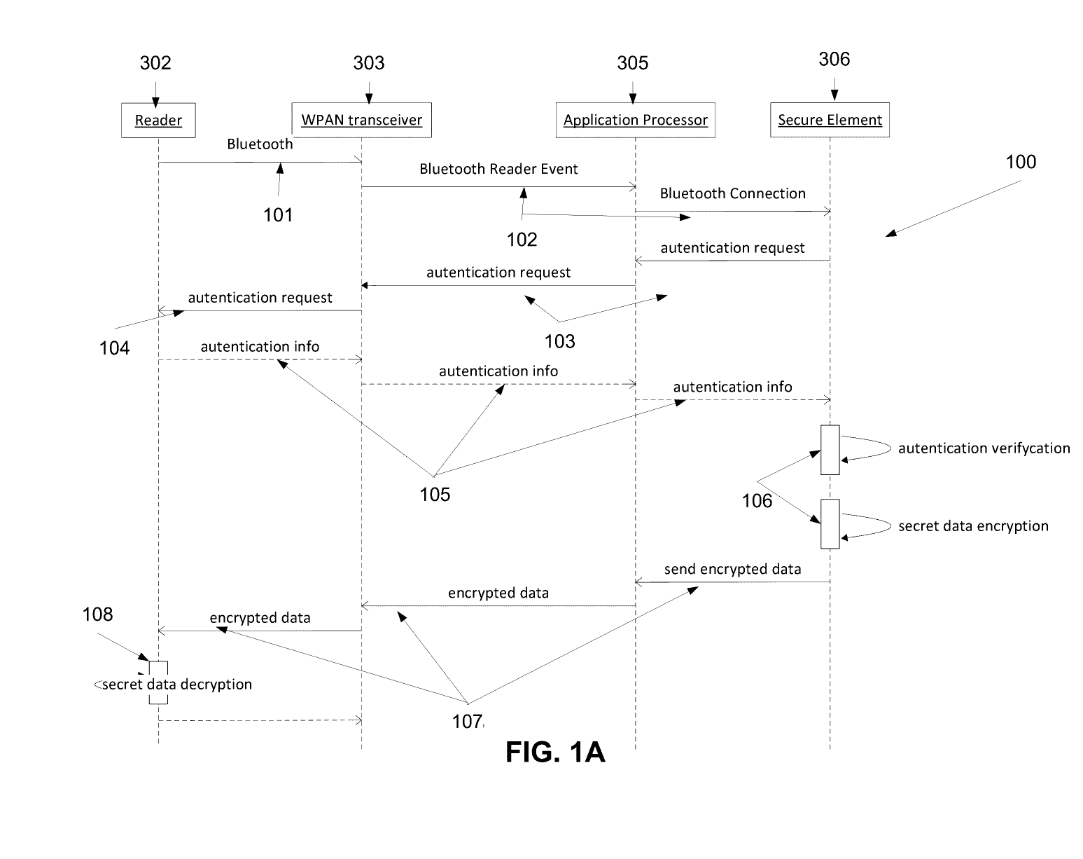

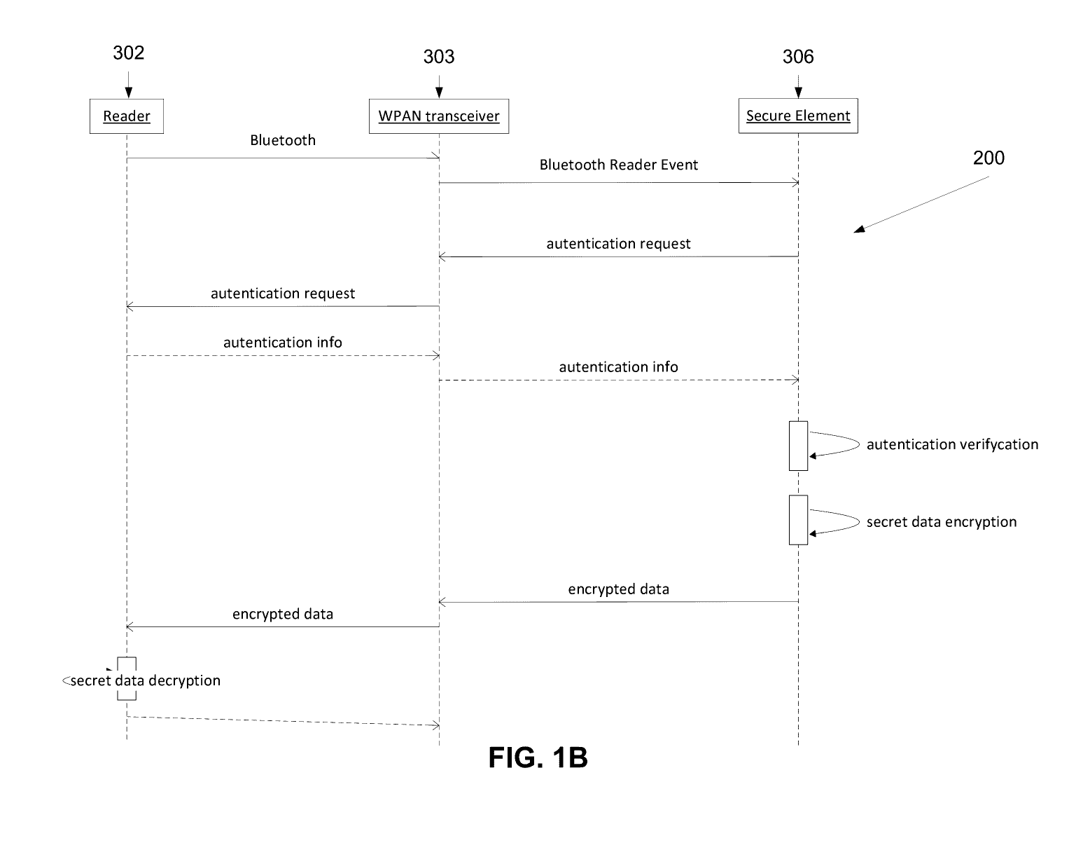

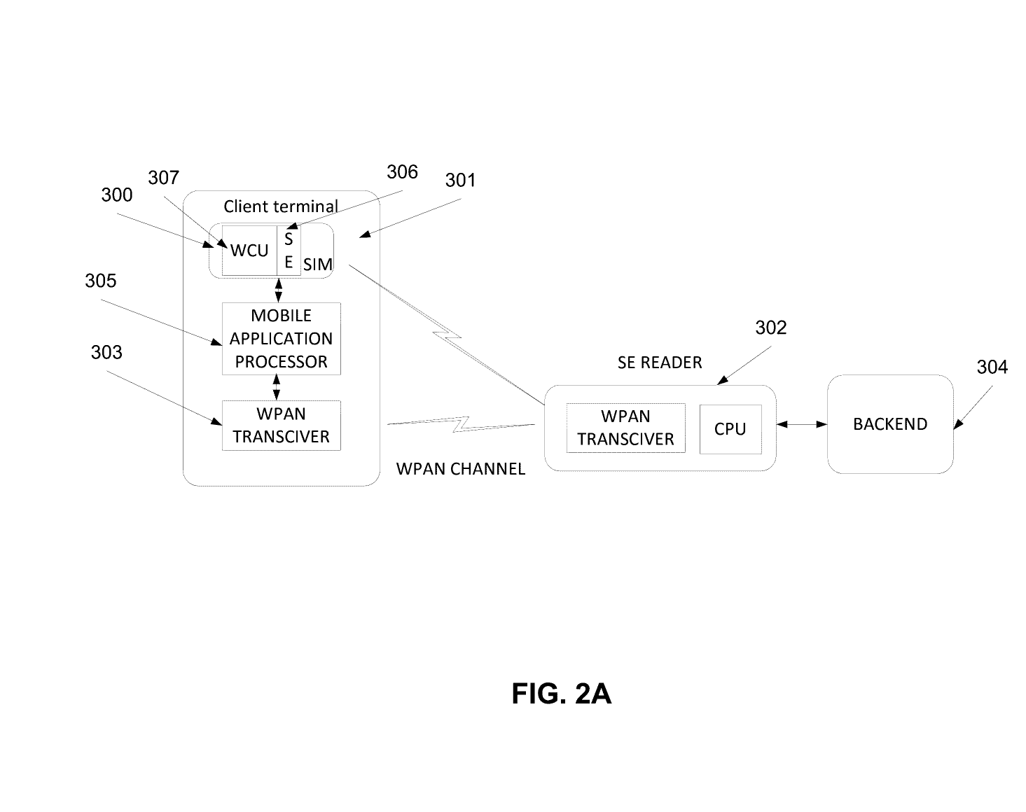

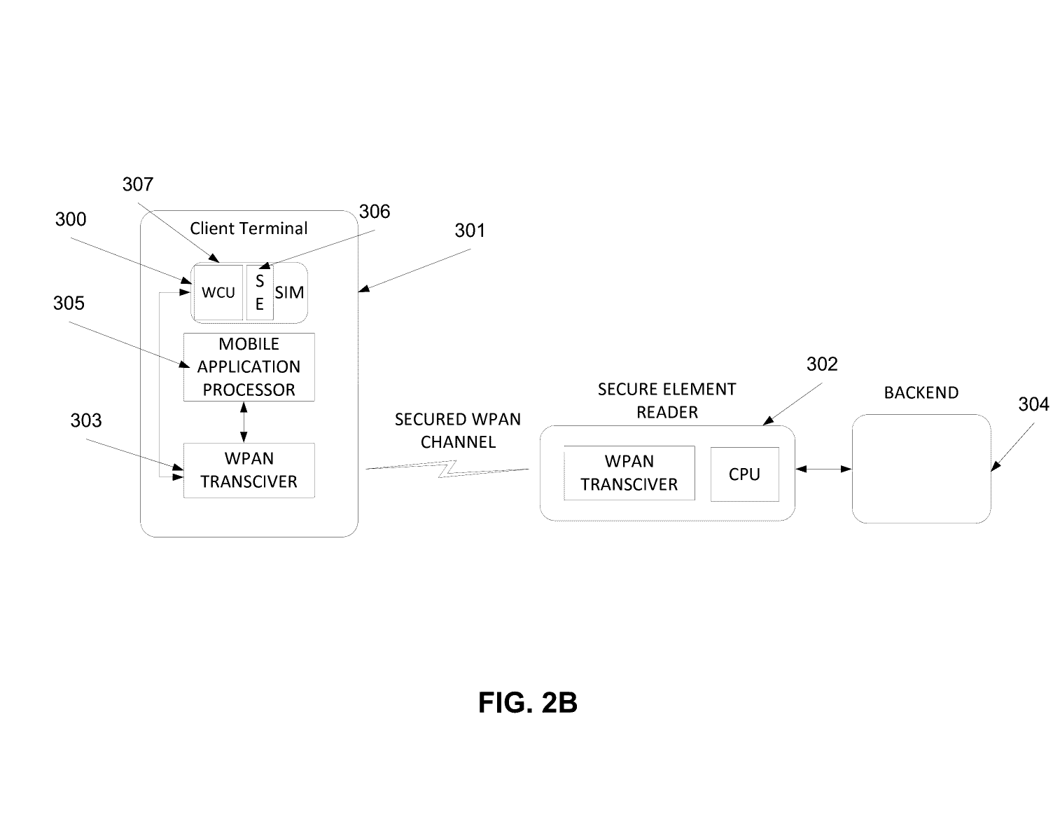

Reference is now made to FIGS. 1A and 1B, which are sequence diagrams of processes 100 200 wherein a secure element (SE) electric card inserted into a secure element (SE) reader slot of a client terminal and stores security data is used for processing authentication data received from a remote party the security data (via a mobile application processor of the hosting client terminal and/or directly using the WPAN transceiver of the client terminal) and for generating a data command transmitted to the WPAN transceiver of the client terminal for further transmission by the WPAN transceiver, for example based on Bluetooth™ (BT) standard, according to some embodiments of the present invention. Process 100 in FIG. 1 depicts messages between components when a mobile application processor is used, for example in Android running client terminals and process 200 in FIG. 2 depicts messages between components when a direct WPAN connection is set between the WPAN transceiver of the client terminal and the SE electric card, for example in iOS running client terminals.

The processes allow a client terminal which hosts the SE electric card to perform NFC transaction(s) without using an integrated NFC module or unit. In these processes, the WPAN transceiver of the client terminal is used as a repeater or an amplifier of the data command so no Application Program Interface (API) are used for delivering data to and from the SE electric card. As used herein an SE electric card is sized and shaped to fit in a standard SE reader, such as a SIM card reader, a Micro SIM reader, and/or the like and to electronically interface with the power and communication pins of the standard SE reader so as to allow powering WPAN electronic card unit(s) which are installed in the SE electric card and optionally for allowing the SE electric card to function as a SIM card or as a Micro SIM card, for example for storing an international mobile subscriber identity (IMSI) and related key used to identify and authenticate subscribers on the client terminal.

Optionally, the SE electric card is a removable plastic card embedded with a SIM circuit and components of depicted in FIGS. 2A and 2B. This plastic card may be transferred between different mobile devices to allow them to perform NFC based transaction although no NFC module is installed or used in the hosting client terminal. Optionally, the removable plastic card follows certain smart card standards, for instance as described in Types of Smart Card, Smart Card Basics, CardLogix Corporation/evolis/SCM Microsystems. Dynamic Application Card Operating System (section), Retrieved 15 Jul. 2013 and incorporated herein by reference.

Optionally, the size of the SE electric card is about 25 mm (2.5 cm length) and about 15 mm (1.5 cm wide). Optionally, the size of the SE electric card is about 12 mm (1.2 cm length) and about 15 mm (1.5 cm wide).

As used herein, a client terminal is a Smartphone, a cellular device, such as a phone, a tablet, a wearable device, such as Google GLASS, a smart watch and/or any handheld device that incorporates an SE reader, such as a SIM or Micro SIM card reader and includes a WPAN transceiver.

As used herein, WPAN is defined according to a BT standard, a Zigbee™ standard, a WLAN standard, such as a WiFi™ standard and/or RFID standard. As used herein, a WPAN transceiver of the client terminal may be a BT system on chip (SoC) or a Zigbee™ SoC, a WLAN module, for example a WiFi™ SoC and/or RFID module, for example RFID SoC and/or the like.

Reference is now also made to FIGS. 2A and 2B, which are schematic illustrations of SE electronic cards 300, each connectable to a client terminal 301 via a secure element (SE) reader slot (not shown) and an SE reader 302 that wirelessly communicate with the SE electronic cards 300 via a WPAN transceiver 303 and a backend 304 that is connected to the WPAN transceiver 303, for example for data authentication, according to some embodiments of the present invention. As outlined above, FIG. 2A depicts a communication between the SE electronic card 300 and the WPAN transceiver 303 via a mobile application processor 305 and FIG. 2B depicts a direct communication between the SE electronic card 300 and the WPAN transceiver 303.

The SE electronic card 300 includes a housing, such as plastic card, sized to be inserted into an SE reader slot of a client terminal that has an SE slot width and an SE slot length and includes a WPAN transducer 303, see for example Motorola iSIM which the specification thereof is attached herein.

The SE electronic card 300 includes a card interface has one or more power supply pins set to be connected to source terminals in the SE reader slot, for example to power supply pins in the SE reader slot. Pins which correspond with VCCA, VCC_C, VBAT, Exposed DAP, NC and/or GND are set in the SE electronic card 300. In such a manner, the hosting client terminal 301 powers the WPAN transceiver 303.

The SE electronic card 300 includes, for example embeds or otherwise electronically connected to an SE circuit 306 that includes an execution environment that includes one or more processing units, such as on chip microprocessors, and a secure memory and that stores security data and a WPAN card unit (WCU 307) 207. The WCU 307 is set to be powered via the power supply pin(s) and electronically wired to a WPAN antenna (not shown) that is used to receive wirelessly authentication data, either directly from a separate SE reader 302 of an external system 304 (see FIG. 2A) and/or from the WPAN transceiver 303. The WPAN antenna has WPAN antenna width and WPAN antenna length which are respectively smaller than the SE slot width and the SE slot length, see for example Motorola iSIM which the specification thereof is attached herein.

The SE electronic card 300 includes, for example embeds or otherwise electronically connected to the execution environment, optionally on chip, that verifies and/or encrypts the received authentication data using the security data from the secure memory 306. The execution environment generates a data command and instructs the transmission of the data command by the WCU 307 to said WPAN transceiver for further transmission of the data command by the WPAN transceiver 303 to the SE reader 302 of the system 304. The card interface, the secure memory, and the BT wireless communication unit are all embedded other otherwise mounted in the housing of the SE electronic card.

Optionally, the WPAN transceiver 303 of the client terminal may function as a buffer, a gateway, and/or a firewall between the SE circuit 306 and the SE reader 302. Optionally, the WCU 307 is initiated only by the WPAN transceiver 303. This may be an outcome of preprocessing pairing and/or due to the limited transmission range of the WCU 307 that allow the WCU 307 to be used for authenticating a short range connection with a receiver at a close proximity, for instance by handshaking protocol for example within few centimeters, namely in the client terminal and does not allow the WCU 307 to be used for authenticating a connection with a receiver that is located more than few centimeters therefrom, for example with a receiver of an external system located more than 10 centimeters from the client terminal 300.

Reference is now made to the authentication process of FIG. 1A which performed when BT standard is implemented in the communication between the WPAN transceiver 303 and the reader 302. First, as shown at 101, the reader 302 of the system 304 sends a BT signal, for instance in a point of sale (POS), for example as a beacon signal that indicates a POS presence. The BT signal is optionally an initiator signal that is part of an RF field that can power passive targets.

As shown at 102, the BT signal is received by the WPAN transceiver 303 of the client terminal 300 and triggers the transmission of a notification to the mobile application processor 305 that set a BT connection with the execution environment of the SE electronic card via the WCU 307 that is optionally a BT SoC.

Optionally, the WPAN transceiver 303 triggers the operation of the WCU 307 when the BT signal is received. The triggering may be by the mobile application processor and/or by a direct API from an application installed at the client terminal or by a direct wireless channel as shown at FIG. 2A.

The execution environment responds to the establishment of the BT connection with an authentication request that is sent, via the application processor, to the WPAN transceiver 303 for transmission to the reader 302, see 103-104.

The reader 302 responds with authentication information to the execution environment 306. As shown at 105, the authentication information is received by the WPAN transceiver 303 and forwarded via the mobile application processor to the execution environment 306. As shown at 106, the execution environment 306 verifies the received authentication information and encrypts at least some of the received authentication information using the security data stored in the secure memory 306. The encrypted data, referred to above as a data commend, is sent via the mobile application processor to the WPAN transceiver 303 for transmission to the reader 302, see 107. Optionally, the transmission from the WPAN transceiver 303 is set for being received by the reader 302 when the reader is at a distance of 10 cm or less from the client terminal 301.

As shown at 108, the reader 302 performs a secured decryption of the encrypted data. This allows the reader to confirm or verify purchases performed using the client terminal 301 and/or to authenticate the presence or absence of a user that is associated with the client terminal 301, for example as performed with NFC. In these embodiments, the WPAN transceiver 303 functions as an amplifier of the data commands sent to the mobile application processor from the execution environment 306. In these embodiments, the WPAN transceiver 303 is used for data transfer, for example of the above data commend(s) to the reader 302, optionally without using APIs for implementing the data transfer on top of the hardware of the client terminal.

Reference is now made to the authentication process of FIG. 1B which is also performed when BT standard is implemented in the communication between the WPAN transceiver 303 and the reader 302. The communication in FIG. 1B is similar to FIG. 1A; however, in FIG. 1B the communication between the execution environment 306 and the WPAN transceiver 303 is performed directly via a BT connection and not via the mobile application processor. In these embodiments, the WPAN transceiver 303 functions as a repeater of the data commands wirelessly received from the execution environment 306 via the WCU 307. In these embodiments, the WPAN transceiver 303 is used for transparent data transfer, for example of the above data commend(s), between two Bluetooth connections, one with the WCU 307 and the other with the reader 302. The WPAN transceiver 303 may be configured as a repeater using AT commands, for example as a standard Serial Port Adapter, for instance Write_Wireless_Multidrop_Configuration(AT*ADWM=), see Bluetooth Repeater Version 3, functional description, SMA Bluetooth™ which is incorporated herein by reference. Optionally, a BT Repeater firmware is installed in the WPAN transceiver 303. The AT commands may be submitted using an application which is installed in the client terminal 300 and has access to the mobile WPAN stack, for example the Bluetooth stack.

By using the WPAN transceiver as a repeater or an adapter, no external antenna has to be connected to the SE electronic card that implements the execution environment 306. As the BT connection that is set with the WCU 307 is established with the WPAN transceiver and not with the reader 302, which may be a reader of a POS, the range of the transmission of the WCU 307 can be limited to few centimeters, for example 1-4 centimeters. As such a transmission requires limited power and limited antenna size, the power source can be SIM card power source (e.g. about 1.8V or about 2.95V as described above and the antenna may be sized and shaped to fit within the boundaries of the SE electric card that is sized and shaped to fit in a slot an SE reader, such SIM or Micro SIM card reader.

A client terminal implementing any of the above protocols using the respective SE electronic cards may be used in contactless payment systems, similar to those currently used in NFC devices, credit cards and electronic ticket smartcards, and allow mobile payment to replace or supplement these systems. For example, such a client terminal may allow a consumer to store credit card number and/or loyalty card information in the secure memory 306 and then to use the client terminal with the SE electronic card at terminals that accept credit cards transactions. Such a client terminal may be used in ticketing systems having a reader, such as 302, for public transport.

Optionally, the above processes are used for emulating an NFC smart card, letting the user of the client terminal tap to initiate transactions with an application (app) of her choice installed in the client terminal, for example an installed application, a web service or the like.

Optionally, a reader app that is installed in the client terminal 301 which is installed with the SE electronic card 300 allows the user to use the client terminal 301 as a reader, such as 302. In such a manner, the client terminal 301 interfaces with other client terminals for performing payments and presence detection and/or for NFC-based transactions.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems are developed and the scope of the term a module, a unit, a transceiver, a client terminal, an electronic card, an SE and a processor is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. An electronic card connectable to a client terminal via a secure element (SE) reader slot, the electronic card comprising:
a housing sized to be inserted into an SE reader slot of a client terminal that has an SE slot width and an SE slot length and a wireless personal area network (WPAN) transceiver;
a secure memory which stores security data;
a WPAN card unit electronically wired to a WPAN antenna that is used to receive wirelessly authentication data, said WPAN antenna having WPAN antenna width and WPAN antenna length which are respectively smaller than said SE slot width and said SE slot length;
an execution environment having at least one processor which encrypts said authentication data using said security data in a data command and instructs the transmission of said data command by said WPAN electronic card unit to said WPAN transceiver for further transmission of said data command by said WPAN transceiver;
wherein said housing contains said secure memory, and said WPAN card unit.

2. The electronic card of claim 1, wherein said WPAN card unit and said WPAN transceiver are Bluetooth transceiver modules.

3. The electronic card of claim 1, further comprising a card interface having at least one power supply pin set to be connected to at least one source terminal in said SE reader slot; wherein said housing contains said card interface; wherein said WPAN card unit set to be powered via said at least one power supply pin.

4. The electronic card of claim 3, further comprising a Subscriber Identification Module (SIM) circuit set to be powered via said at least one power supply pin and to communicate with a client terminal execution environment of said client terminal for establishing a cellular connection.

5. The electronic card of claim 1, wherein said SE slot width and said SE slot length are respectively about 15 mm and about 25 mm or about 15 mm and about 12 mm.

6. The electronic card of claim 1, wherein said client terminal is a cellular device.

7. The electronic card of claim 1, wherein said execution environment instructs the transmission of said data command by said WPAN electronic card unit to said WPAN transceiver via a mobile application processor.

8. The electronic card of claim 7, wherein said authentication data is received from said mobile application processor.

9. The electronic card of claim 1, wherein said WPAN electronic card unit directly and wirelessly sends said data command to said WPAN transceiver via a wireless connection.

10. (canceled)

11. A method for using a wireless personal area network (WPAN) transceiver of a client terminal for secure element (SE) communication, comprising:
providing an SE electronic card sized to be inserted into an SE reader slot of a client terminal having a wireless personal area network (WPAN) transceiver;
wherein said SE reader slot having an SE slot width and an SE slot length;
wherein said SE electronic card includes, an execution environment having at least one processor, a secure memory which stores security data and a WPAN antenna having WPAN antenna width and WPAN antenna length which are respectively smaller than said SE slot width and said SE slot length;
wirelessly receiving authentication data card at said SE electronic and using said WPAN antenna;
locally generating at said execution environment a data command encrypting said authentication data using said security data; and
transmitting said data command, using said WPAN antenna, to said WPAN transceiver for further transmission of said data command by said WPAN transceiver.

12. The method of claim 11, wherein said data command is sent to confirm a payment using said client terminal.

13. A computer program product for using a wireless personal area network (WPAN) transceiver of a client terminal for secure element (SE) communication, said computer program product comprising:
a computer readable storage medium having stored thereon:
first program instructions executable by an execution environment of an SE electronic card sized to be inserted into an SE reader slot of a client terminal having a wireless personal area network (WPAN) transceiver to cause said SE electronic card to for wirelessly receiving authentication data;
wherein said SE reader slot having an SE slot width and an SE slot length;
wherein said SE electronic card includes said execution environment and a secure memory which stores security data and a WPAN antenna having WPAN antenna width and WPAN antenna length which are respectively smaller than said SE slot width and said SE slot length;
second program instructions executable by said execution environment to cause said SE electronic card to generate a data command encrypting said authentication data using said security data; and
third program instructions executable by said execution environment to cause said WPAN antenna to transmit said data command to said WPAN transceiver for further transmission of said data command by said WPAN transceiver.
